(19) United States
(12) Patent Application Publication
(10) Pub. No.: US 2026/0049937 A1
(43) Pub. Date: Feb. 19, 2026

(54) DEVICE FOR DETECTING HLB DISEASE

(71) Applicant: UNIVERSIDAD SIMÓN BOLÍVAR, Barranquilla, Atlántico (CO)

(72) Inventors: Reynaldo VILLARREAL GONZÁLEZ, Barranquilla, Atlántico (CO); Nataly GALÁN FREYLE, Barranquilla, Atlántico (CO); Leonardo PACHECO LONDOÑO, Barranquilla, Atlántico (CO); Yani ARANGUREN DÍAZ, Barranquilla, Atlántico (CO); Elwi MACHADO SIERRA, Barranquilla, Atlántico (CO); Antonio ACOSTA HOYOS, Barranquilla (CO)

(21) Appl. No.: 19/104,076

(22) PCT Filed: Aug. 16, 2023
(86) PCT No.: PCT/CO2023/000014

§ 371 Date: Feb. 14, 2025

(30) Foreign Application Priority Data
Aug. 17, 2022 (CO) NC2022/0011594

(51) Int. Cl. G01N 21/64; G01N 21/84

(52) U.S. Cl. CPC G01N 21/6486; G01N 21/84; G01N 2021/8466; G01N 2201/0221; G01N 2201/062; G01N 2201/0636

(57) ABSTRACT

The portable device for early disease identification allows in situ detection of the disease by analyzing the plant's leaf directly and visually identifying the degree of disease spread in the plant.

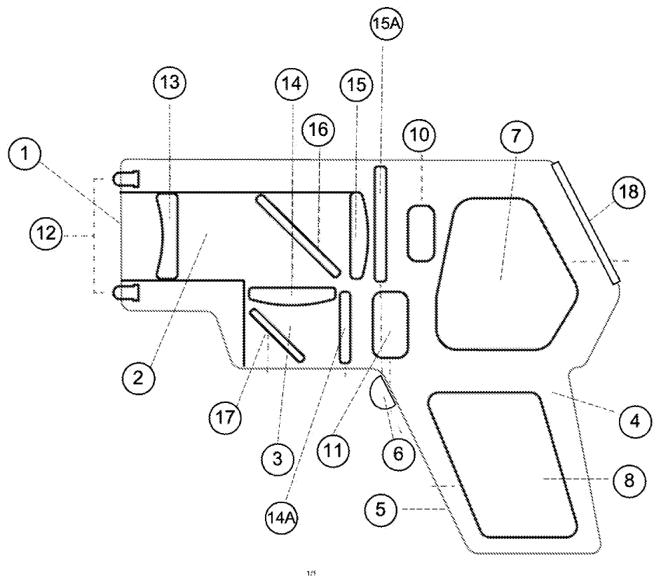

The present invention belongs to the field of measurement instruments, specifically those related to spectrometry applied to the detection of microorganisms.

The portable device for early disease identification allows in situ detection of the disease by analyzing the plant's leaf directly and visually identifying the degree of disease spread in the plant.

### STATE OF THE ART

In the state of the art, certain solutions have been found that serve as background to the invention presented. Among them, application US2004021860 ‘Method for the detection of pathogenic organisms’ uses an analysis method through Raman spectroscopy and then identifies the existence of certain pathogens by comparing particle sizes.

Among the main differences between the found solution and the one sought to be protected, we note that the proposed invention allows in situ detection through a portable device, provides immediate visibility of the progress and level of HLB infection in the plant, and enables instant sample analysis through the device.

### BRIEF DESCRIPTION OF THE INVENTION

The device operates by detecting the fluorescence spectrum produced by the bacteria on the leaves in a range of 500-1000 nm. This allows for a rapid field test, distinguishing plants infected with HLB from those with other diseases or malnutrition due to the specific light spectrum analyzed. Additionally, a larger number of tests can be conducted across more plants in a crop, enabling real preventive actions.

### DETAILED DESCRIPTION OF THE INVENTION

The HLB disease affects citrus crops worldwide. In the Colombian Caribbean, 90% of citrus crops were lost in 2019 due to this bacterial disease. The disease is difficult to detect because its early stages in the plant are asymptomatic, and the bacteria have not yet been successfully cultured for identification.

In terms of prevention, the ability to perform in situ tests is sought, as laboratory sample analysis increases disease identification time and raises the risk of infection and plantation loss.

The portable device for early disease identification allows in situ detection by analyzing the plant's leaf directly and visually identifying the degree of disease spread.

### EXAMPLE

In an example application of the provided invention, the device is positioned at a distance of no more than 2 cm from the leaf, and the activation button is pressed. The LED lights illuminate the leaf, which reflects the excitation light as luminescence. This luminescence is captured by the first lens and directed to the beam splitter, which divides it into two identical halves and redirects each beam to the rear lenses.

What is claimed is:

1. A portable spectroscopic device, comprising: an entry opening; a conduit connected to the entry; a front chamber connected to the conduit; a rear chamber in the handle or grip; an activation button located in the handle and connected to a control module; and a screen.

2. The device of claim 1, wherein two LED bulbs are arranged in the entry opening.

3. The device of claim 1, characterized by comprising three lenses located in the entry of the device, the conduit, and the front chamber, respectively.

4. The device of claim 1, wherein a beam splitter is arranged between the rear lenses and the front chamber.

5. The device of claim 1, wherein a mirror is arranged under the lens of the front chamber.

6. The device of claim 1, characterized by comprising two filters positioned behind the lens of the conduit and the mirror, respectively.

7. The device of claim 1, characterized by comprising a camera and a microspectrometer positioned behind the filters.

8. The device of claim 1, characterized by comprising a control module connected to the camera and the microspectrometer.

9. The device of claim 1, characterized by integrating a power source in the rear chamber.

10. The device of claim 1, characterized by integrating a screen in the upper rear part.
